(19) United States
(12) Patent Application Publication
(10) Pub. No.: US 2007/0043189 A1
(43) Pub. Date: Feb. 22, 2007

(54) Amphoteric copolymer

(75) Inventors: Kung-Chung Hsu, Taipei City, TW (US); Fu-Ti Jiang, Banciao City (TW); Jun-Wei Chen, Taipei City (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: National Taiwan Normal University

(21) Appl. No.: 11/406,324

(22) Filed: Apr. 19, 2006

(30) Foreign Application Priority Data
Aug. 16, 2005 (TW) 094127830

(51) Int. Cl. C08F 4/30

(52) U.S. Cl. 526/318.43; 526/303.1; 526/317.1; 526/229

(57) ABSTRACT

This invention relates to an amphoteric copolymer, and the use of the copolymer to improve the fluidity and fluidity retention of cementitious materials. The chemical structure of the copolymer is as follows: 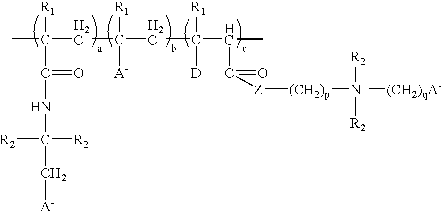
wherein R₁ is H or CH₃;
R₂ is a hydrogen atom, or an alkyl group, a cyclic aliphatic group or an aryl group, having 1 to 10 carbon atoms;
D is H or COOR₃, R₃ is a hydrogen atom, or an alkyl group, a cyclic aliphatic group or an aryl group, having 1 to 10 carbon atoms, or a cationic salt group; Z is an O atom or an NH group;
A is a —COO group, a —SO₃ group or an acid form; a, b, or c is an integer from 1 to 5000; and p and q are integers from 1 to 10.

### BACKGROUND OF THE INVENTION

1. Field of the Invention

The present invention relates to an amphoteric copolymer having a very good dispersing effect on a cementitious material, and such copolymer is added to a cementitious material such as cement paste or concrete to improve the fluidity and fluidity retention or the workability and workability retention of the material.

2. Description of the Related Art

Concrete is made by mixing cement, water, fine and coarse aggregates, and admixtures in a specific proportion. Since concrete has the advantages including its easy access, low price, low pollution, and good compressive strength, therefore concrete becomes a popular construction material used extensively for houses, bridges, and dam constructions. In recent years, the construction quality has been improved, the scale of constructions becomes increasingly large, and the performance of traditional concrete no longer meets actual requirements, and thus a so-called high-strength concrete (HSC) is introduced. In general, HSC is made with a lower water/cement ratio, which gives a higher compressive strength. Compared with the traditional concrete of the same conditions, HSC can reduce the cross-sectional area of the construction, decrease the weight of the construction, and enhance the area of land and the use of space, and thus improving the overall beneficial result of the design and construction. Therefore, the application of HSC can be extended to the construction of tall buildings and undersea tunnels. However, HSC is relatively sticky and viscous, and its workability is not as good. Therefore, HSC still has certain problems in constructions, and thus a high-performance chemical admixture is developed later to overcome the foregoing shortcomings. The concrete technology is also developed from HSC to high performance concrete (HPC) and self-compacting concrete (SCC). Refer to “Current Situations and Perspectives of High Performance Concrete” by Chen, J. C. in Proceeding of the Conference of Mix Design and Practice of High Performance Concrete, Taipei, 1998, pp 1-17; and “High Performance Concrete” by Aitcin, P. C., E & F. N. Spon, London, 1998.

Compared with the traditional concretes, HPC and SCC have stronger strength, and the major feature resides on their excellent fluidity. In a construction process using traditional concretes, it requires tamping or vibration to avoid having honeycombs or voids formed in the construction, and both HPC and SCC do not need tamping nor vibration, and they can be filled automatically in the construction site without segregation of the materials. Therefore, this new construction material is practically used for the constructions of skyscrapers, highways, long-span bridges, nuclear plants, high-speed railways, and rapid transit systems, now.

Among all kinds of superior features of HPC, the excellent fluidity is the most eye-catching one, primarily because HPC has added a superplasticizer. “It is believed that the development of superplasticizers is a major breakthrough which will have a very significant effect on the production and use of concrete in years to come” said Dr. Malhotra, Program Manager, Advanced Concrete Technology Program, CANMET (Minerals and Metals Sector of Natural Resources Canada). Superplasticizer is also known as a high-range water reducer having a function of enhancing the dispersion of cement or aggregate, and thus it can reduce the quantity of water and improve the strength of concrete, or it can increase the workability of concrete without changing the mix composition. Unlike general water reducers, a large quantity of the superplasticizer can be added without producing serious retarding or air-entraining effects. Therefore, when HPC with a high fluidity is produced, the control of the properties of the chemical admixture is very important. In general, the type, dosage, and composition of chemical admixtures, the electrical charges present at the surface of cement particles, the hydration and dispersing behavior of cement or aggregate, and the properties of newly mixed or hardened concrete will affect the production of HPC. As to the same type of chemical admixture, the molecular weight, the side-chain length of the pendant group, the polarity or ionic property of functional groups, and the monomer ratio in the copolymer are major factors affecting the fluidity of HPC.

The superplasticizer of previous generations is a sulfonate-based admixture, such as modified ligninsulfonates (MLS), sulfonated naphthalene formaldehyde condensates (SNF), and sulfonated melamine formaldehyde condensates (SMF) for producing a dispersing effect by the electrostatic repulsion, and its water-reduction rate can reach 15˜30%, and the workability of concrete can be maintained to 45 min˜1 hr. The new-generation superplasticizer is a carboxylate-based admixture, and its molecular structure generally bears long poly-ethoxylated side chain (CAE), and its dispersing effect includes not only electrostatic repulsion, but also steric hindrance. The water-reduction rate can reach up to 40%, and the slump flow can be maintained for more than 1 hr. Since the superplasticizer plays an important role of enhancing the workability of concrete, and thus improving the dispersing effect of a superplasticizer becomes a subject that demands immediate attention in the industry.

At present, most dispersing agents, regardless of sulfonated-based or carboxylate-based admixtures, are anionic polymers or copolymers, and there is still no amphoteric polymer or copolymer.

Refer to “Innovative Applications of Superplasticizers in Concrete” by Malhotra, V. M. in Mario Collepardi Symposium on Advances in Concrete Science and Technology, Rome, 1997, pp 271-314; Rixom, M. R. and Mailvaganam, N. P. Chemical Admixtures for Concrete, 2nd Edition, E.& F. N. Spon, London, 1986; Ramachandran, V. S.; Malhotra, V. M.; Jolicoeur, C.; Spirattos, N. Superplasticizers: Properties and Applications in Concrete; CANMET: Ottawa, Ontario, 1998.

### SUMMARY OF THE INVENTION

The primary objective of the present invention is to provide an amphoteric copolymer having a very good dispersing effect on cementitious materials.

Another objective of the present invention is to provide an amphoteric copolymer, and particularly a method of manufacturing such amphoteric copolymer.

A further objective of the present invention is to provide an amphoteric copolymer as a cementitious material, particularly used for improving the fluidity and the fluidity retention of a cement paste or the workability and the workability retention of a concrete.

In this patent specification, the acronyms are elaborated as follows:

PAMD is a copolymer of AMPSA, MMA, and DAAE;

AMPSA is 2-acrylamido-2-methylpropane sulfonic acid;

MAA is methacrylic acid;

DAAE is (α-N,N-dimethyl-N-acryloyloyethyl)ammonium ethanate;

PAMD is an AMPSA/MAA/DAAE copolymer [copoly(2-acrylamido-2-methylpropane sulfonic acid/methacrylic acid/(α-N,N-dimethyl-N-acryloyloyethyl) ammonium ethanate)];

QAMD is a copolymer of AMPSA, MAA, and DAE.

DAE is [(α-N,N-dimethyl-N-(3-(β-carboxylic)acrylamino)propyl)ammonium ethanate];

MA is maleic anhydride;

CDPA is [β-carboxylic acid-N-(3-dimethyl aminopropyl)acrylamide];

MLS is a modified ligninsulfonate;

SNF is a sulfonated naphthalene formaldehyde condensate;

SMF is a sulfonated melamine formaldehyde condensate;

QAMD: is an AMPSA/MAA/DAE copolymer [copoly(2-acrylamido-2-methylpropane sulfonic acid/methacrylic acid/(α-N,N-dimethyl-N-(3-(β-carboxylic acid)acrylamino)propyl)ammonium ethanate).

The water soluble copolymer of the present invention has the following structure:

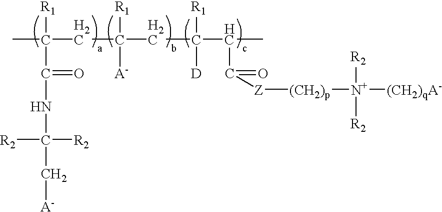

Where, R₁ could be H or CH₃;

R₂ is a hydrogen atom, or an alkyl group, a cyclic aliphatic group, or an aryl group, having 1 to 10 carbon atoms;

D is H or COOR₃, R₃ is a hydrogen atom, or an alkyl group, a cyclic aliphatic group, or an aryl group, having 1 to 10 carbon atoms, or a cationic salt group;

Z is an O atom or an NH group;

A is a —COO group, a —SO₃ group or an acid form;

a, b, or c is an integer from 1 to 5000; and

p and q are integers from 1 to 10.

Particularly, an amphoteric copolymer—PAMD of the present invention has the following structure:

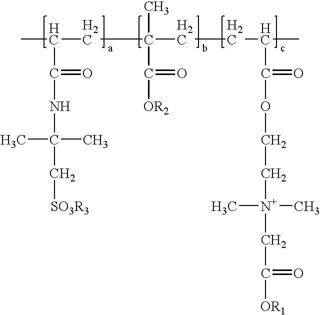

Wherein R₁, R₂, and R₃ are H, NH₄ or an alkaline metal; and a, b, and c are integers from 1 to 5000.

The dispersing agent of the present invention is an amphoteric copolymer—PAMD. The 2-(dimethylamino)ethyl acrylate and sodium chloroacetate are reacted to produce DAAE, and the DAAE is reacted with AMPSA and MAA in different proportions through a free radical polymerization to produce a copolymer (PAMD). The amphoteric copolymer is added to cement paste and concrete for the fluidity test, and the result shows that the amphoteric copolymer concurrently has the steric hindrance and electrostatic repulsive force, and thus can improve the fluidity and fluidity retention of cement paste and the slump flow and slump flow retention of concrete, and the required dosage is lower than that of the present commercial carboxylate-based (HP-100) and sulfonated-based (HPC1000) superplasticizer. Therefore, the amphoteric copolymer of the present invention is definitely a good cement dispersing agent.

Further, the present invention provides another dispersing agent QAMD for the cement that has the following structure:

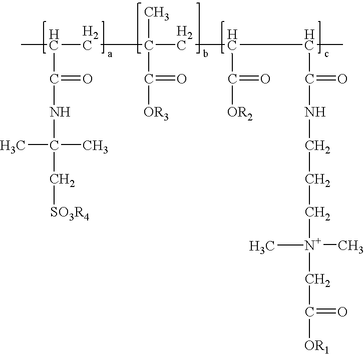

Wherein R₁, R₂, R₃, and R₄ are H, NH₄ or an alkaline metal; and a, b, and c are integers from 1 to 5000.

The dispersing agent of the present invention is an amphoteric copolymer—QAMD. The maleic anhydride and N,N-dimethyl-1,3-propane diamine are reacted to produce CDPA, which is reacted with sodium chloroacetate to form DAE, and the DAE monomer conducts a free radical polymerization with AMPSA and MAA to obtain a copolymer (QAMD). Such amphoteric copolymer is added to cement paste and concrete for a fluidity test, and the result shows that the QAMD amphoteric copolymer of the invention gives a good effect on the fluidity and the fluidity retention of cement paste and the slump flow and the slump flow retention of concrete, and the required dosage is lower than that of the present commercial superplasticizer. Therefore, the QAMD amphoteric copolymer is definitely a very good cement dispersing agent.

### BRIEF DESCRIPTION OF THE DRAWINGS

FIG. 1 is an IR spectrogram of a monomer DAAE;

FIG. 2 is an ¹H-NMR of DAAE;

FIG. 3 is an IR spectrogram of a copolymer PAMD;

FIG. 4 is an ¹H-NMR spectrogram of a copolymer PAMD;

FIG. 5 is an IR spectrogram of a copolymer QAMD;

FIG. 6 is an ¹H-NMR spectrogram of a copolymer QAMD.

### DETAILED DESCRIPTION OF THE PREFERRED EMBODIMENTS

The method of synthesizing a monomer and a copolymer is illustrated by the following embodiments:

### Embodiment 1

(1) Synthesis of Monomer DAAE

Dissolve 36.9 portions of 2-(dimethylamino)ethyl acrylate and 29.7 portions of sodium chloroacetate into 150 portions of water in a reactor, and perform a magnetic stir at room temperature for 24 hours, and extract with an appropriate amount of acetone to obtain a lower-level sticky and viscous liquid. Put the liquid into a vacuum oven and bake it in vacuum at 25° C. to obtain the DAAE monomer, and the yield rate is approximately 95%.

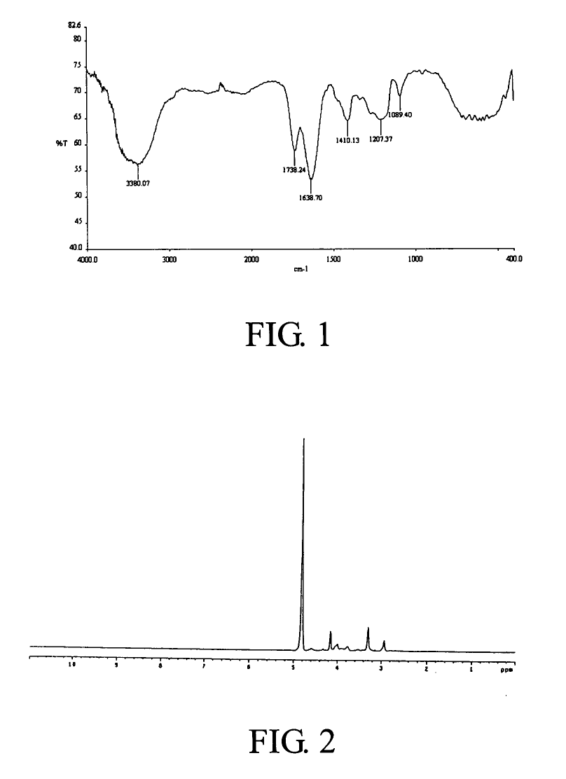

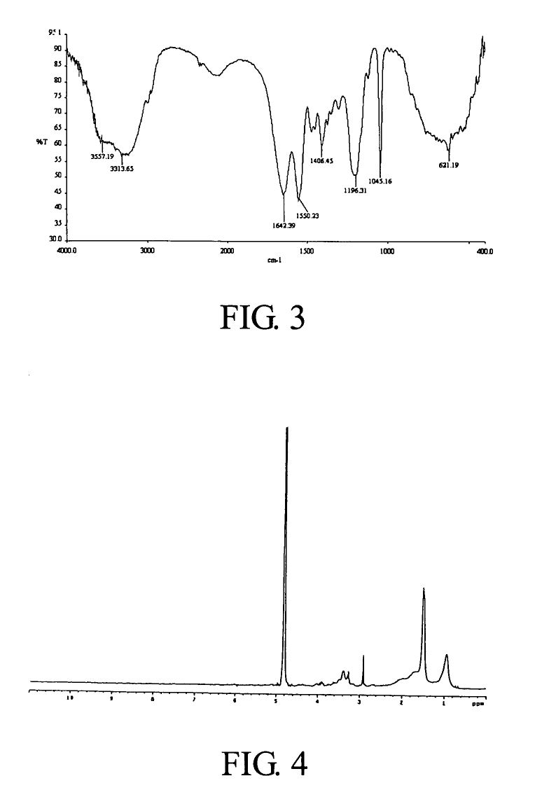

The infrared (IR) spectrogram of DAAE is shown in FIG. 1, wherein the absorption peaks include: 3380 cm⁻¹ (—OH), 1738 cm⁻¹ (—C═O), 1638 cm⁻¹ (—C═C), 1410 cm⁻¹ (—C—O), 1207 cm-1 and 1089 cm⁻¹ (—C—O—C). The ¹H-NMR (Nuclear Magnetic Resonance) spectrogram is shown in FIG. 2, wherein δ=2.9, 3.3, 3.7, 3.9, 4.1 ppm each having a resonant peak.

(2) Synthesis of Copolymer PAMD

Weigh the required monomer (DAAE), 2-acrylamido-2-methylpropane sulfonic acid (AMPSA) and methacrylic acid (MAA) (monomer proportion is shown in Table 1), and put them in a reactor containing distilled water. Adjust with 4N NaOH solution to alkaline and add a small quantity of initiator ammonium persulphate or chain transfer agent 2-sodium methallyl sulfonate drop by drop, and react in a nitrogen gas atmosphere at 70° C., for 2 hours, and the solution becomes a light yellow color. Extract by acetone to obtain a light yellow precipitate. The yield rate is approximately 70˜80%. Add a few drops of inhibitor hydroquinone after purifying, and put the substance in a vacuum oven at 25° C. to remove the acetone in the vacuum, and then add deionized water to dissolve the substance to obtain the PAMD.

The IR spectrogram of PAMD is shown in FIG. 3, wherein the absorption peaks include: 3313 cm⁻¹ (—OH), 1642 cm⁻¹ (—C═O), 3557 cm⁻¹ and 1550 cm⁻¹ (—N—H), 1400 cm⁻¹ (—C—O), 1196 cm⁻¹ (—C—O—C), 1045 cm⁻¹ (—S═O), and 621 cm⁻¹ (—S—O). The ¹H-NMR (Nuclear Magnetic Resonance) spectrogram is shown in FIG. 4, wherein δ=0.9, 1.5, 2.7, 2.9, 3.3, 3.4, 3.9 ppm and each has a resonant peak. The molecular weight of each copolymer is measured by a gel permeation chromatography (GPC), and the results are listed in Table 1.

### Embodiment 2

(2) Synthesis of CDPA

Dissolve 49 portions of maleic anhydride into 200 portions of acetone, and put 51 portions of N,N-dimethyl-1,3-propane diamine into a feed inlet. In an ice bath, add N,N-dimethyl-1,3-propane diamine drop by drop. The reaction proceeds for 2 hours. After the reaction, the mixture was vacuum filtered, washed with acetone, and the filtered solid was dried in a vacuum oven at room temperature for 2 days to collect CDPA monomer.

(2) Synthesis of DAE

Weigh the aforementioned sample of CDPA monomer, and dissolve 80 portions of CDPA monomer by 240 portions of deionized water, and adjust with 4N NaOH solution to pH=9˜10, and then add 47.2 portions of sodium chloroacetate. Stir the mixture at room temperature for 6 hours, and purify the mixture by acetone, and bake it in an oven to obtain a DAE monomer. The yield rate is approximately 90%.

(3) Synthesis of Copolymer QAMD

Weigh the monomer DAE, 2-acrylamido-2-methylpropane sulfonic acid (AMPSA) and methacrylic acid (MAA) (Refer to Table 2 for the monomer proportion), and put these substances into a reactor containing distilled water, and adjust with 4N NaOH solution to alkaline, and add a small quantity of initiator ammonium persulphate or chain transfer agent 2-sodium methallyl sulfonate drop by drop, and react in a nitrogen gas atmosphere at 60° C. for 2 hours. The solution turns into a light yellow color. After extracting by acetone, a yellow precipitate is obtained, and the yield rate is approximately 75˜85%. After purifying, add a few drops of inhibitor hydroquinone, and put the substance in a vacuum oven and bake it at 25° C. to remove the acetone in vacuum, and add deionized water to dissolve the substance to obtain QAMD.

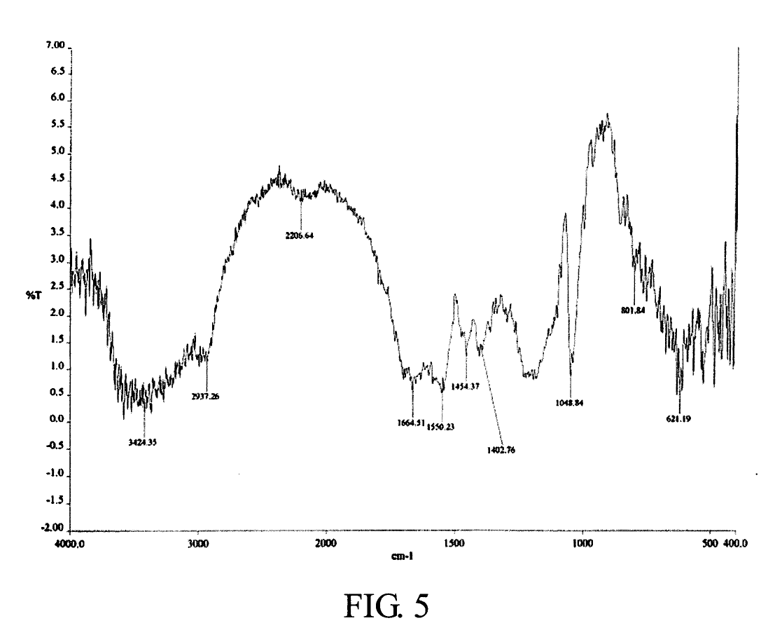

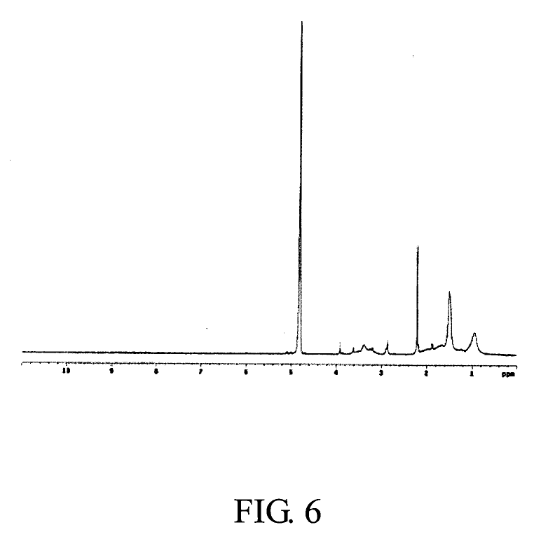

The IR spectrogram of QAMD is shown in FIG. 5, wherein the absorption peaks include: 3500 cm⁻¹ (—OH), 1664 cm⁻¹ (—C═O), 3424 cm⁻¹ and 1550 cm⁻¹ (—N—H), 1048 cm⁻¹ (—S═O), and 621 cm⁻¹ (—S—O). The ¹H-NMR (Nuclear Magnetic Resonance) spectrogram of PAMD is shown in FIG. 6, wherein δ=0.9, 1.5, 2.9, 3.2, 3.4, and 3.9 ppm, and each has a resonant peak.

### Embodiment 3

Mix a cement paste having a water/cement ratio (W/C) of 0.3, and Portland cement (manufactured by Taiwan Cement Corporation) is adopted, and the added dosage of the dispersing agent is 0.2-1.0 wt % (relative to the weight of dry cement powder), and use a mini-slump cone (which is a circular cone having an upper diameter of 20 mm, a lower diameter of 40 mm, and a height of 60 mm), and then measure the diameter of the spread cement paste, which represents its mini-slump value.

There are two types of dispersing agents, one is the dispersing agent of the present invention and the other is the commercial superplasticizer HPC1000 (sulfonate-based superplasticizer, made by Hi Con Chemical Admixture Taiwan, Ltd.) and HP-100 (carboxylate-based superplasticizer, made by Poplar Co., Ltd.) In the mixing process, obtain 650 g of cement and add water and dispersing agent into a mixing bowl and let it sit still for 30 seconds, and then slowly stir it for 30 seconds and let it sit still for 30 seconds again, and finally stir it for 1 minute. In the testing process, place a glass sheet on a horizontal tabletop, and set the mini-slump cone at the center of the glass sheet, and fill up with the mixed cement paste, and tap both sides of the mini-slump cone 5 times each to make sure the fill-up and then quickly pull up the mini-slump cone to measure the average diameter of the spread paste, which will be the mini-slump or fluidity of the cement paste at the initial stage (0 min.); and then let the cement paste sit still for 1 hour, and measure its spread diameter again, which is the mini-slump of the cement paste at a later stage (1 hour). If the mini-slump at the later stage is getting close to the mini-slump at the initial stage, then the slump retention or fluidity retention of the paste is getting better.

Table 3 lists the dosage of dispersing agent and the mini-slump of cement paste incorporated with the dispersing agent PAMD or QAMD of the present invention and the commercial superplasticizer. The results show that under the condition of a water/cement ratio (W/C)=0.3, and no dispersing agent is added, the cement paste will not spread, and the mini-slump value equals to 4 cm. If the dispersing agent is added, then the fluidity of the cement paste will be increased. When the dosage of the dispersing agent PAMD of the present invention is about 0.3-0.4 wt %, or the dosage of QAMD is 0.2-0.5 wt %, the mini-slump value of the cement paste at the initial stage (0 min.) and that at the mini-slump at the later stage (1 hour) are both over 16 cm. The required dosage of commercial superplasticizer (HPC1000, HP-100) will be larger, which equals 0.8-1.0 wt %, so as to make both mini-slumps of the cement paste at the initial stage (0 min.) and at the later stage (1 hour) to reach to 16 cm. Therefore, the copolymer of the present invention can be used as a dispersing agent to increase the mini-slump value of the cement paste, and the added amount is less than that of the commercial superplasticizer (HPC1000, HP-100) to achieve the same dispersing effect and mini-slump value (>16 cm), and maintain the slump retention.

### Embodiment 4

Table 4 shows the composition of concrete, and the materials include water, Portland cement (made by Taiwan Cement Corporation), blast-furnace slag and fly ash (produced by China Hi-ment Corporation), dispersing agent (SP), fine aggregate, and coarse aggregate (max. particular size is 19 mm). The water/binder ratio (W/B) of concrete is 0.366 wt % and there are two types of dispersing agents, one being the dispersing agent of the present invention and the other being the commercial superplasticizer HPC1000 (sulfonate-based superplasticizer produced by Hi Con Chemical Admixture Taiwan, Ltd.) and HP-100 (carboxylate-based superplasticizer produced by Poplar Co., Ltd.), and the added dosage of dispersing agent is 0.24-0.88 wt % (relative to the dry weight of the binder). The slump flow values designed for the concrete at 0 min. and 1 hour are approximately 60*60 cm². The concrete is mixed according to the requirements of the ASTM C192, and the value of slump flow is measured by a slump cone compliant with the ASTM C143. The mixing and slump flow measurement of the concrete were conducted in the Research & Development Center of Goldsun Development & Construction Co., Ltd. Table 5 shows 12 groups of dispersing agents, the dosage and the slump flow of the concrete.

Table 5 shows that the required dosage of the dispersing agent PAMD of the present invention is approximately 0.28-0.36 wt %, or the required dosage of QAMD is approximately 0.24-0.32 wt % to make the slump flow values of the concrete at the initial stage (0 min.) and the later stage (1 hour) over 60*60 cm², and the required dosage of commercial superplasticizer (HPC1000, HP-100) is larger, which is approximately 0.32-0.88 wt % to make the slump flow values of the concrete both at the early stage and the later stage equal to 60*60 cm². Therefore, the copolymer PAMD or QAMD of the present invention is used as a dispersing agent to improve the workability of the concrete and increase the value of slump flow, and such method requires less dosage than that of the commercial superplasticizer (HPC1000, HP-100) to achieve the same dispersing effect or the same value of slump flow (60*60 cm²), and maintain the value of slump flow and the slump flow retention. The result shows that the copolymer of the present invention has a superior dispersing performance, and can improve the slump flow and slump flow retention of concrete.

It is worth pointing out that the invention has been described by means of specific embodiments, numerous modifications and variations could be made thereto by those skilled in the art without departing from the scope and spirit of the invention set forth in the claims.

Table/Figure:

TABLE 1
Monomer Proportion and Molecular Weight of Copolymer PAMD

| Code | a | b | C | Mw* |
|---|---|---|---|---|
| PAMD2 | 4 | 10 | 1 | 92000 |
| PAMD3 | 6 | 10 | 1 | 111000 |
| PAMD4 | 8 | 10 | 1 | 101000 |
| PAMD6 | 6 | 10 | 1 | 55000 |

*Mw: Weight Average Molecular Weight

TABLE 2
Monomer Proportion and Molecular Weight of Copolymer QAMD

| Code | AMPSA | MAA | DAE | Mw* |
|---|---|---|---|---|
| QAMD1 | 1 | 5 | 1 | 52000 |
| QAMD3 | 13 | 5 | 1 | 49000 |

*Mw: Weight Average Molecular Weight

TABLE 3
Dosage of Dispersing Agent and Mini-Slump of Cement Paste
(W/C = 0.3)

| | | | 0 min. | |
|---|---|---|---|---|
| | | | mini- | 60 min. |
| | Superplasticizer | Dosage | slump | mini-slump |
| | Code | (wt %) | (cm) | (cm) |
| Dispersing Agent | PAMD2 | 0.3 | 20 | 16.5 |
| of the | | 0.4 | 20 | 18 |
| Present Invention | PAMD3 | 0.3 | 19 | 18 |
| | | 0.4 | 20.5 | 19.5 |
| | PAMD4 | 0.3 | 18 | 17 |
| | | 0.4 | 19.5 | 18.5 |
| | PAMD6 | 0.4 | 19 | 17 |
| | QAMD1 | 0.4 | 17.5 | 17 |
| | | 0.5 | 18 | 18 |
| | QAMD3 | 0.2 | 19 | 19 |
| | | 0.25 | 20 | 20 |
| Commercial | HPC1000 | 0.6 | 14 | 10 |
| Superplasticizer | | 0.8 | 17 | 15 |
| | | 1.0 | 17.5 | 16 |
| | HP100 | 0.6 | 13.5 | 18.5 |
| | | 0.8 | 18 | 19.5 |
| | | 1.0 | 19 | 20 |

TABLE 4
Mix Proportion of Concrete

| W/B* | | | | Fine | Coarse |
|---|---|---|---|---|---|
| (wt | SP/B** | Water | Binder | Aggregate | Aggregate |
| %) | (wt %) | (Kg/m³) | (Kg/m³) | (Kg/m³) | (Kg/m³) |
| 0.366 | 0.24- | 150 | 410 | 943 | 890 |

| | | | |
|---|---|---|---|
| 0.88 | Cement | Slag | Fly |
| | | | ash |
| | 246 | 49 | 115 |

*W/B = Water/Binder
**SP/B = Dispersing Agent/Binder

TABLE 5
Dosage of Dispersing Agent and Workability of Concrete

| | | | | 0 min. | 1 hr. |
|---|---|---|---|---|---|
| | Dispersing | Dispersing | | Slump | Slump |
| Concrete | Agent | Agent | Dosage | flow | flow |
| Class | Type | Code | (wt %) | (cm²) | (cm²) |
| 1 | Dispersing | PAMD3 | 0.28 | 62 * 61 | 62 * 59 |
| 2 | Agent of the | | 0.32 | 62 * 61 | 63 * 62 |
| 3 | Present | | 0.36 | 65 * 63 | 68 * 62 |
| 4 | Invention | QAMD3 | 0.24 | 63 * 67 | 63 * 63 |
| 5 | | | 0.28 | 65 * 67 | 64 * 64 |
| 6 | | | 0.32 | 64 * 64 | 65 * 60 |
| 7 | Commercial | HPC1000 | 0.64 | 20 * 20 | 20 * 20 |
| 8 | Superplasticizer | | 0.72 | 59 * 56 | 55 * 57 |
| 9 | | | 0c.8 | 60 * 61 | 57 * 58 |
| 10 | | | 0.88 | 61 * 61 | 60 * 57 |
| 11 | | HP100 | 0.28 | 51 * 53 | 46 * 47 |
| 12 | | | 0.32 | 70 * 68 | 52 * 50 |

In summation of the above description, the present invention herein enhances the performance and overcomes the shortcoming of the prior art, and further complies with the patent application requirements.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An amphoteric copolymer, comprising a structure of 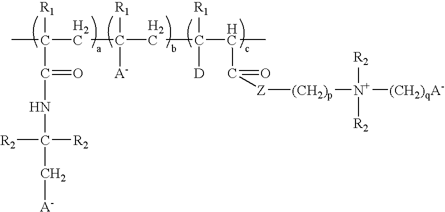
Wherein R₁ is H or CH₃;
R₂ is H, an alkyl group, a cyclic aliphatic group, or an aryl group, having 1 to 10 carbon atoms;
D is H or COOR₃, and R₃ is H, an alkyl group, a cyclic aliphatic group or an aryl group, having 1 to 10 carbon atoms, or a cationic salt group;
Z is O or NH;
A is a —COO group, a —SO₃ group, or an acid form;
a, b, and c are integers from 1 to 5000; and
p and q are integers from 1 to 10.

2. An amphoteric copolymer (PAMD), comprises a structure of: 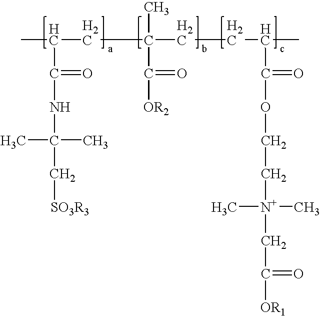
Wherein R₁, R₂, and R₃ are H, NH₄ or alkaline metal, and a, b, and c are integers from 1 to 5000.

3. An amphoteric copolymer (QAMD), comprising a structure of: 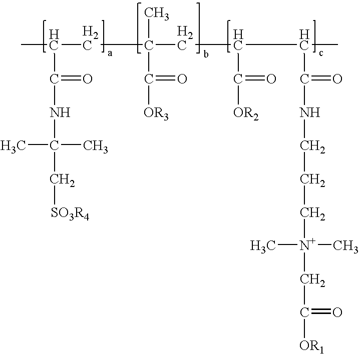
Wherein, R₁, R₂, R₃, and R₄ are H, NH₄, or an alkali metal, and a, b, and c are integers from 1 to 5000.

4. A water soluble monomer (DAAE), comprising a structure of: 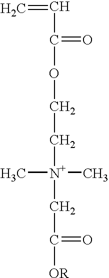
Wherein R is H, NH₄, or an alkaline metal.

5. A water soluble monomer (DAE), comprising a structure of: 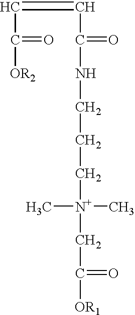
Wherein R₁ and R₂ are H, NH₄ or an alkaline metal.

6. A method for preparing a PAMD copolymer of claim 2, comprising the steps of:
obtaining a DAAE monomer of claim 4;
adding 1 to 5000 portions of a monomer of 2-acrylamido-2-methylpropane sulfonic acid (AMPSA) and methacrylic acid (MAA) into a reactor containing water, and adjusting with NaOH solution to alkaline;
adding a small quantity of initiator and chain transfer agent into said reactor drop by drop, and reacting at 50□˜70□ for 2˜3 hours; and
turning the solution into a light yellow color, and extracting by acetone, and adding a few drops of inhibitor after purifying, and placing in a vacuum oven to remove acetone, and dissolving by adding deionized water, so as to obtain said copolymer.

7. The manufacturing method of claim 6, wherein said NaOH solution has a concentration of 4N.

8. The manufacturing method of claim 6, wherein said initiator is ammonium persulphate.

9. The manufacturing method of claim 6, wherein said chain transfer agent is 2-sodium methallyl sulfonate.

10. The manufacturing method of claim 6, wherein said inhibitor is a hydroquinone.

11. A method of producing a QAMD copolymer of claim 3, comprising the steps of:
obtaining a DAE monomer of claim 5, and adding 1 to 5000 portions of each monomer of 2-acrylamido-2-methylpropane sulfonic acid (AMPSA) and methacrylic acid (MAA) into a rector containing water, and adjusting with NaOH solution to alkaline;
adding a small quantity of initiator and chain transfer agent into a reactor drop by drop, and reacting at 50□˜70□ for 2˜3 hours;
turning the solution into a yellow color, and extracting by acetone, and adding a few drop of inhibitor after purifying, and placing in a vacuum oven to remove acetone, and dissolving by deionized water, so as to obtain said copolymer.

12. The manufacturing method of claim 11, wherein said NaOH solution has a concentration of 4N.

13. The manufacturing method of claim 11, wherein said initiator is ammonium persulphate.

14. The manufacturing method of claim 11, wherein said chain transfer agent is 2-sodium methallyl sulfonate.

15. The manufacturing method of claim 11, wherein said inhibitor is a hydroquinone.

16. The copolymer of claim 1, being used as a cementitious material having a very good dispersing effect.

17. The copolymer of claim 1, being used for enhancing the fluidity and fluidity retention of said cement paste.

18. The copolymer of claim 1, being used for enhancing the workability and workability retention of said concrete.
